(19) United States
(12) Patent Application Publication
(10) Pub. No.: US 2002/0035655 A1
(43) Pub. Date: Mar. 21, 2002

(54) Method of checking for and recovering from underruns and overrun slips when writing to circular buffers in dynamic bandwidth circuit emulation services

(76) Inventors: Dawn Finn, Kanata (CA); George Jeffrey, Nepean (CA)

Correspondence Address: MARKS AND CLERK, P O BOX 957, STATION B, 55 METCALFE STREET, SUITE 1380, OTTAWA, ON, K1P5S7, CA

(21) Appl. No.: 09/950,674

(22) Filed: Sep. 13, 2001

Related U.S. Application Data
(60) Provisional application No. 60/236,171, filed on Sep. 29, 2000.

(30) Foreign Application Priority Data
Sep. 15, 2000 (GB) 0022683.7

(51) Int. Cl. G06F 5/00; G06F 3/02; G06F 3/023

(52) U.S. Cl. 710/60; 710/52

(57) ABSTRACT

A method of managing buffers in a SAR (Segmentation and Reassembly) device in a cell-relay network in dynamic bandwidth circuit emulation mode involves reading out TDM data from a buffer at a location determined by a read pointer, and writing data from incoming cells commencing at a buffer location determined by a write pointer. The write pointer is incremented as data from incoming cells are written into said buffers. On arrival of an incoming cell a determination is made as to the location of said write pointer. If the location of the write pointer lies between a first value equal to the location of the read pointer plus a predetermined maximum lead plus a predetermined DBCES buffer less the number of bytes per active channel and a second value equal to the location of the read pointer plus said predetermined DBCES buffering, an overrun condition is declared. If the location of said write pointer exceeds the location of the read pointer plus the predetermined maximum lead plus the predetermined DBCES buffer, an underrun condition is declared. This method takes into account additional buffering that is required to prevent underruns and overruns when operating in DBCES mode.

### CROSS REFERENCE TO RELATED APPLICATIONS

This application claims the benefit under 35 USC 119(e) of U.S. provisional application No. 60/236,171.

### FIELD OF THE INVENTION

This invention relates to the field of digital communications, and more particularly to a method of checking for and recovering from underruns and overrun slips when writing to circular buffers in Dynamic Bandwidth Circuit Emulation Services.

### BACKGROUND OF THE INVENTION

ATM (Asynchronous Transfer Mode) is a service that carries data in small fixed size packets or cells over a packet switched network. The cells are statistically multiplexed on fixed physical links between network nodes and establish virtual circuits over the network between endpoints. ATM includes a number of specifications of which AAL1 (ATM Adaptation Layer 1) establishes standard for carrying time sensitive data, such as voice or video, over the virtual circuits between the endpoints. This is known as circuit emulation (CES) because it provides a number of voice channels that to the user appear similar, for example, to time division multiplexed channels.

DBCES is a mode of dynamic bandwidth utilization in an ATM network based on detecting which time slots of a given TDM trunk are active and which are inactive. When an inactive state is detected in a specific time slot, the time slot is dropped from the next ATM structure and the bandwidth it was using may be reutilised for other services. DBCES is described in detail in ATM Forum specification: af-vtoa-0085.000 (July 1997).

Devices known as SARs (Segmentation and Reassembly) devices convert incoming data to cells and vice versa. SARs include buffers for storing the cells to be processed, arriving at the far end are converted to data ATM (Asynchronous Transfer Mode) is a cell-relay based digital communications system that permits the establishment of virtual circuits over a packet switched network.

Mitel Corporation sells an AAL1 SAR device known as the MT90500 for transferring time-sensitive traffic between a TDM bus and an ATM cell stream. Details of this device can be found on Mitel's website at http://www.mitelsemi.com/index.html. In the MT90500, data from incoming ATM cells is written into circular buffers at locations determined by a write pointer and read out of the circular buffer at appropriate times for insertion into TDM channels by a read pointer. The separation between the read and write pointers determines the level of buffering occurring at any instant. If there is insufficient data in the buffer to fill the corresponding TDM time slot, an underruns occurs. If data in the circular buffer is overwritten with new data before it has been read out onto a TDM channel, an overrun occurs. Both these conditions are obviously undesirable and are generally referred to as frame slips.

In the MT90500, a comparison is made between the write-pointer value and the read-pointer value. Depending on the distance between the two pointers (and based on comparison to the Minimum Lead and Maximum Lead user-defined parameters), an underrun or overrun is declared and the write-pointer is adjusted to a slip-pointer value to aid in the prevention of further slip occurrences (underrun or overrun). If the write-pointer points to an illegal location closer to Minimum Lead than to Maximum Lead, an underrun is declared; if the write-pointer points to an illegal location closer to Maximum Lead than Minimum Lead, an overrun is declared. An “illegal” location is one that does not lie between the Minimum Lead and Maximum Lead.

In our co-pending application of even date we have propose improvements to the underrun and overrun detection to make it more intelligent than in the MT90500 when used in the SDT (Structured Data transfer) mode.

The improvements include the use of “turn” bits to distinguish better between overruns and underruns, particularly when a data stream has ceased (e.g., cut VC). As well, different criteria are used to distinguish between underruns and overruns. In accordance with the teachings of our copending application:

if the write-pointer is located somewhere between the location to which the read-pointer is pointing, and the value of read-pointer plus Maximum_Lead (2*CDV), whre CDV is the cell delay variation, no slip is considered to have occurred. Therefore, the write-pointer is not adjusted.

if the write-pointer is located between the value of the “read-pointer plus Maximum_Lead” and the value of the “read-pointer plus Maximum_Lead plus a cell”, an overrun is considered to have occurred.

“read-pointer plus Maximum_Lead plus a cell” is calculated on the fly as pointing to an address ahead of the read-pointer by Maximum_Lead (as programmed by the user) plus the maximum number of bytes which may be written to a Reassembly Circular Buffer upon a cell arrival (e.g., if there is only one channel it a VC, a maximum of 47 channels may be written to the VC's circular buffer when a cell is received; if there are 23 channels in a VC, a maximum of 3 channels may be written to one of the VC's circular buffers upon a cell arrival).

if the write-pointer exceeds the value of the “read-pointer plus Maximum_Lead plus a cell”, an underrun condition is considered to have occurred.

This slip-checking routine is designed for SDT (Structured Data Transfer) operation and does not take into consideration the special additional buffering required to prevent the occurrence of underruns and overruns when operating in DBCES mode. The criteria used to distinguish between normal, overrun, and underrun conditions need to be adjusted to take this buffering into consideration.

An object the invention is to differentiate between normal, underrun, and overrun conditions when writing to a circular buffer while operating in DBCES mode.

### SUMMARY OF THE INVENTION

According to the present invention there is provided a method of managing buffers in a SAR (Segmentation and Reassembly) device in a cell-relay network in dynamic bandwidth circuit emulation mode, comprising reading out TDM data from a buffer at a location determined by a read pointer; writing data from incoming cells commencing at a buffer location determined by a write pointer; incrementing said write pointer as data from incoming cells are written into said buffers; and

wherein on arrival of an incoming cell a determination is made as to the location of said write pointer, and:

(i) if the location of the write pointer lies between a first value equal to the location of the read pointer plus a predetermined maximum lead plus a predetermined DBCES buffer less the number of bytes per active channel and a second value equal to the location of the read pointer plus said predetermined DBCES buffer, an overrun condition is declared; and

(ii) if the location of said write pointer exceeds the location of the read pointer plus said predetermined maximum lead plus said predetermined DBCES buffer, an underrun condition is declared.

The above method normally runs in conjunction with normal slip checking as applied to standard CES operation (SDT).

In condition (ii) case, since the write-pointer should normally have been prevented form getting so far ahead of the read-pointer, it is more likely that instead of being in an overrun condition, the write-pointer is not in fact so far ahead of the read-pointer, but instead has actually fallen behind the read-pointer, for example, due to a break in a virtual circuit or a fast clock relative to the transmitter clock.

The invention thus permits differentiation between underruns and overruns when operating in DBCES mode.

### BRIEF DESCRIPTION OF THE DRAWINGS

The invention will now be described in more detail, by way of example only, with reference to the accompanying drawings, in which:

FIG. 1 shows the normal, overrun, and underrun conditions of SDT reassembly circular buffers in SDT mode;

FIG. 2 shows a normal write operation to an SDT reassembly circular buffer in DBCES mode;

FIG. 3 shows an overrun write operation to an SDT reassembly circular buffer in DBCES mode; and

FIG. 4 shows an underrun write operation to an SDT reassembly circular buffer in DBCES mode.

### DETAILED DESCRIPTION OF THE PREFERRED EMBODIMENTS

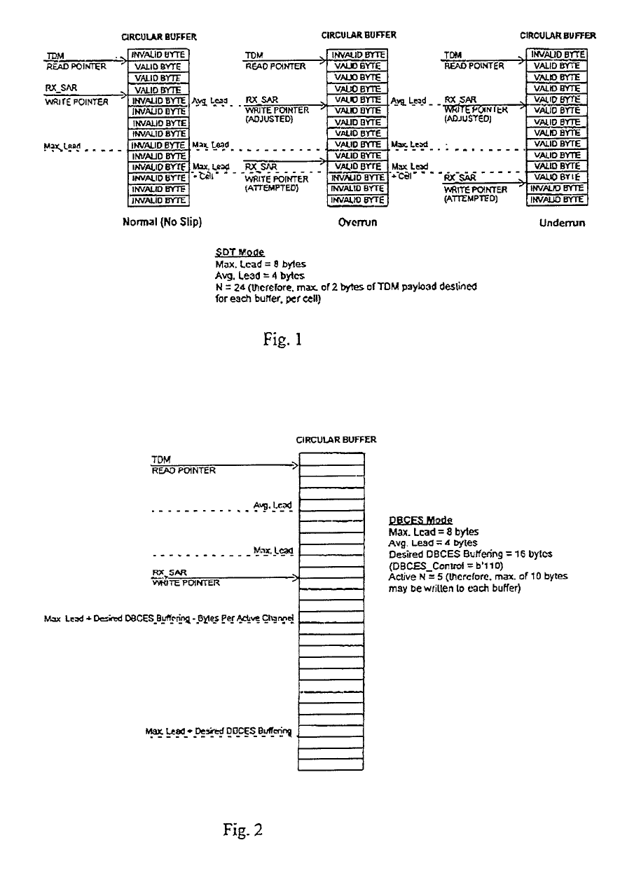

Referring now to FIG. 1, in “normal” or basic SDT (Structured Data Transfer) operation, cells arrive at the SDT receiving SAR (RX_SAR) at a regular rate, with some cell delay variation (CDV) caused by varying delays in the transmission circuitry. Since the cells arrive “on average” at the same rate, they are generally written to the circular buffers at an average distance away from the read-pointer (the average distance being ˜CDV). Due to cell delay variation, cells can arrive slower or faster than average, but no slips should occur, if there is always a number of cells equal to CDV in the buffer. Only when extreme situations occur (e.g., a Virtual Circuit is cut, or the receiver and transmitter clocks are greatly askew), will slips occur.

In FIG. 1, which shows the operation of the buffers in SDT mode, the INVALID BYTES represent bytes that have already been read or in the case of start-up never been written. In the normal condition where the writer pointer falls in the window between the Min. lead and Max. lead parameters, the new data is written directly following the old data. The minimum and maximum lead parameters define a window within the circular buffer within which cell data can be received without generating an underrun or overrun condition. These locations are always determined relative to the read-pointer location, which of course increments as the TDM data is read out of the buffer.

In the case of an underrun condition, the write pointer is located after the Max lead position and is moved to the average lead position. This results in VALID data that has not yet been read out being overwritten. In the case of an underrun condition, the write-pointer is located before the Min. lead parameter and is again moved to the average position, resulting in previously read bytes being skipped. When this data is read out onto the TDM bus, it can either be replaced by silence or repeated.

In the DBCES mode of operation, however, cells can sometimes arrive with a delay greater than or less than CDV. Such situations occur regularly, when the number of active channels in a virtual circuit changes. As a result, the cells cannot always be written to the buffer at a distance of CDV away from the read-pointer, or slips will occur. Therefore, considerations have to be made to generate a slip-pointer value which would prevent repeated slips. As a result, a new method had to be devised to differentiate between underruns and overruns when operating in DBCES mode.

In FIGS. 2 to 4, it is assumed that the maximum lead is 8 bytes, the average lead is 4 bytes, the desired buffering for DBCES is 16 bytes, and the number of active channels is 5, which means that a maximum of ten bytes per cell can be written to each buffer.

If, as shown in FIG. 2, the write-pointer is located somewhere between the location to which the read-pointer is pointing, and the value of read-pointer+Maximum_Lead+active-channel CDV buffer limit for the VC, no slip is considered to have occurred and the next arriving cell is written at the location of the write pointer.

The active-channel CDV buffer limit for the VC is calculated as the number of bytes of DBCES buffering desired by the user (as configured by the setting of the DBCES Control field in the DBCES Reassembly Control Structure for the VC), less the maximum number of bytes which can be written to each SDT Reassembly Circular Buffer for the VC, given the activity profile of the VC. For example, if there are two active channels in the VC, a maximum of 24 bytes of data can be written to either circular buffer upon the arrival of a cell since a cell carries a payload of 47 bytes. Rounding 47/2 gives a maximum of 24 bytes per channel.

If, as shown in FIG. 3, when an incoming cell arrives, the write-pointer is located between the value of “read-pointer plus Maximum_Lead, plus the active-channel CDV buffer limit for the VC” and the “read-pointer plus Maximum_Lead, plus the desired DBCES buffer limit for the VC”, an overrun is considered to have occurred because there is a possibility that if a cell is written at this location, some of the data already stored in the circular buffer, but not yet read, would be overwritten (see FIG. 3).

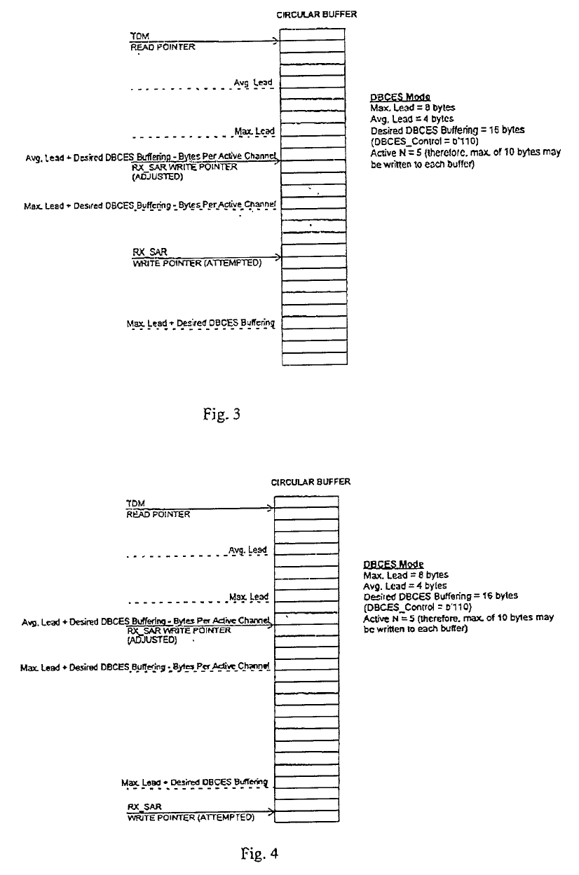

If, as shown in FIG. 4, upon arrival of an incoming cell the write-pointer exceeds the value of the “read-pointer plus Maximum_Lead, plus the desired DBCES buffer limit for the VC”, an underrun condition is considered to have occurred and the write pointer value is adjusted to the value average lead plus desired DBCES buffering less the number of bytes per active channel. This is considered to be an underrun, because the “normal” and “overrun” checking should have prevented the write-pointer from getting this far “ahead” of the read-pointer. It is more likely that the write-pointer has fallen behind the read-pointer (e.g. due to a cut VC condition or a fast read-clock relative to the transmitter clock) and that the read-pointer is actually pointing to old data that has not yet been overwritten by the receiver.

Of course, it will be understood by one skilled in the art that the size of the read-pointer and write-pointer values can be varied, for example, to include more turn bits, could give better determination of whether a slip was really an overrun or an underrun.

The invention thus provides an effective method of recovering from underrun and overrun slips when operating in DBCES mode.

1. A method of managing buffers in a SAR (Segmentation and Reassembly) device in a cell-relay network in dynamic bandwidth circuit emulation mode, comprising:
reading out TDM data from a buffer at a location determined by a read pointer;
writing data from incoming cells commencing at a buffer location determined by a write pointer;
incrementing said write pointer as data from incoming cells are written into said buffers; and
wherein on arrival of an incoming cell a determination is made as to the location of said write pointer, and:
(i) if the location of the write pointer lies between a first value equal to the location of the read pointer plus a predetermined maximum lead plus a predetermined DBCES buffer less the number of bytes per active channel and a second value equal to the location of the read pointer plus said predetermined DBCES buffer, an overrun condition is declared; and
(ii) if the location of said write pointer exceeds the location of the read pointer plus said predetermined maximum lead plus said predetermined DBCES buffer, an underrun condition is declared.

2. A method as claimed in claim 1, wherein the cell-relay network is an ATM network and the number of bytes per active channel is determined by dividing 48 by the number of active channels.

3. A method as claimed in claim 1, wherein upon declaration of an overrun or underrun condition, said write pointer is moved to a predetermined location relative to said read pointer.

4. A method as claimed in claim 1, wherein said predetermined location is given equal to the average lead plus the predetermined DBCES buffering less the number of bytes per active channel.

5 A method as claimed in claim 4, wherein the average lead is equal to the cell delay variation for the cell-relay network.

6. A method as claimed in claim 5, wherein the maximum lead is equal to the maximum lead that does not cause an overrun in normal non-BDCES mode.
